(19) United States
(12) Patent Application Publication
(10) Pub. No.: US 2023/0353597 A1
(43) Pub. Date: Nov. 2, 2023

(54) DETECTING MATCHES BETWEEN UNIVERSAL RESOURCE LOCATORS TO MITIGATE ABUSE

(71) Applicant: Bitly, Inc., New York, NY (US)

(72) Inventors: Matthew Ratzloff, New York, NY (US); Scott Schaefer, New York, NY (US); Angel Martinez, New York, NY (US); Mavreen Marra Smiel, New York, NY (US)

(21) Appl. No.: 18/141,010

(22) Filed: Apr. 28, 2023

Related U.S. Application Data
(60) Provisional application No. 63/336,420, filed on Apr. 29, 2022.

(51) Int. Cl. H04L 9/40

(52) U.S. Cl. CPC H04L 63/1483; H04L 63/1425

(57) ABSTRACT

The present disclosure is directed to systems and methods for determining a match between uniform resource locators (URL) fragments. A server may maintain a record for a first URL against which to compare. The first URL may have a first domain name, a first path name, and first strings. The record may include a first keys for a corresponding first URL fragments from the first URL. Each first URL fragment may have the first domain name, the first path name, and a first permutation of the first strings. The server may generate a second keys using a corresponding second URL fragments from a second URL. Each second URL fragment may have a second domain, a second path name, and a second permutation of the second strings. The server may determine a match between at least one of the first keys and at least one of the second keys.

### CROSS REFERENCES TO RELATED APPLICATIONS

The present application claims priority under 35 U.S.C. 119(e) to U.S. Provisional Pat. Application No. 63/336,420, titled “Detecting Matches Between Universal Resource Locators to Mitigate Abuse,” filed Apr. 29, 2022, which is incorporated herein by reference in its entirety.

### BACKGROUND

In a computer network environment, a computing device may access an information resource (e.g., a webpage) via a link. The link may be an address referencing a location in the network via which the information resource is accessible.

### SUMMARY

A computing device may use a link to access an information resource (e.g., a webpage) hosted on a server in a computer networked environment. The link may be an address in the form of a Uniform Resource Locator (URL) referring to the information resource on the server. The URL for the link may be comprised of a set of string components, such as a scheme, a domain name, a path (e.g., one or more directories and a file name), and a query, among others. In the URL, the domain name may uniquely refer to the server on which the information resource is hosted and the path may refer to the specific information resource. The other string components, such as the scheme and query, may be used to define the accessing of the information resource.

URLs may be compared to determine whether the links refer to the same information resource on the same server for a variety of purposes. For instance, certain links may be URLs may refer to information resources with malware, phishing, spam, spyware, and other abuses or security vulnerabilities. To identify link as corresponding to such information resources, a service may compare a new URL with URLs stored and labeled as fraught with security vulnerability for a match. URL comparison and matching may be difficult to perform, incurring a significant amount of computing resources in terms of processing and memory consumption and a great duration of time from processing the URLs. This may be exacerbated given that there may be a massive volume of URLs referring to unique information resources and a variety of URLs referring to the same information resource.

To address these and other technical challenges, a link processing service may maintain records of abuse URLs using keys, values, and rules to apply in event of a match with a URL with which to compare. Upon receiving a HTTP containing one or more abuse URLs (e.g., from a vendor or administrator), the service may parse each URL and process the constituent components of the URL to generate a record. If the URL contains a query string, the service may remove the tracking parameters from the URL. Using the components identified from the URL, the service may derive or generate a set of URL fragments. The URL fragments may contain the domain name and the path, as well as permutations of other string components. For example, the service may take the URL “https://www.x.y/1/2.html?param=1” to generate the following URL fragments: “www.x.y/1/2.html”, “www.x.y/1/2.html?param=1”, “x.y/1/2.html”, and “x.y/1/2.html?param=1”.

With the derivation of the URL fragments, the service may generate a key and a value for a corresponding URL fragment in the record. The key may be, for example, of the following format: a transposition of the domain name appended with a one-way hash of the URL fragment. The format may allow for quick and exact look-ups upon retrieval, while allowing for related keys for the domain to be co-located with efficient storage and lookup in a partitioned key-value store. Furthermore, the service may set a set of report data by source (e.g., a vendor or administrator) as the value for the URL fragment. For instance, the service may prefix a value representing a taxonomy of abuse type with a source identifier corresponding to the source. The service may also include any additional information to process the record at the time of lookup. This may allow for extensibility as well as the ability to store data specific to a particular source. The service may store the URL components along with the corresponding keys and values in the record for the URL in the form of key-value stores. The record may be stored for any path in the URL and for an entire domain with appropriate value to define a granular rules to apply to the path or domain, thereby providing flexibility in fine-tuning a measure to perform in response to abusive URLs.

In addition, the service may associate or include a rule to apply to a given record, URL, or URL fragment of the record. The rule may be stored with or separately from the record to allow for flexibility in applying rules and changing the specifications for the rules in real-time. The rule may define or specify various factors, such as a trust score to represent a degree of trust for a given data source or inputs for a given geographic region, among others. The input may be obtained from a variety of sources, such as data for a given data source or user, infrequently changing algorithms to cache data with a set time duration, and queries for the URL records, among others. The inputs and factors for the rules may be used to dynamically generate a set of scores by taxonomy for a given URL. The scores may be used to adjudicate whether the page is to be flagged or blocks. For example, an interstitial may be provided to warn the user with the option to click through or to notify the user that the page is inaccessible.

Subsequently, the service may receive a request to retrieve a URL to lookup values associated with the URL. In performing the lookup, the service may derive URL fragments from the requested URL. For example, the service may split the URL “https://www.x.y/1/2.html?param=1” into the following URL fragments: “www.x.y/”, “www.x.y/1/”, “www.x.y/1/2.html”, “www.x.y/1/2.html?param=1”, “x.y/”, “x.y/1/”, “x.y/1/2.html”, and “x.y/1/2.html?param=2” among others. The URL fragments may be expanded to include permutations of the path name as well as the other constituent strings from the original URL. The service may generate a key for each URL fragment, and compare the generated keys to the keys of the URL records. When a match is found, the service may identify the rule to apply for the matching key and provide an output in accordance with the rule. The output may identify a classification of URL abuse. Otherwise, when no match is found, the service may identify the URL as safe.

By generating keys from URL fragments derived from the requested URLs in this manner, the service can quickly process the URL to determine matches with URLs catalogued in the records. Relative to other URL matching techniques, the generation of keys from the URL fragments to compare against other keys may save computing resources in terms of processing and memory and may also reduce the amount of time from processing the URLs. With the quick processing, the service may be able to provide the output indicating whether the URL is safe or abusive in a prompt manner. This may lower or eliminate potentially harmful exposure to security vulnerabilities, from malware, phishing, spam, and spyware, among others, present in resources linked to unsafe URLs.

Aspects of the present disclosure are directed to systems, methods, and computer-readable media for determining a match between uniform resource locators (URL) fragments. A server may maintain a record for a first URL against which to compare. The first URL may have a first domain name, a first path name, and one or more first strings. The record may include a first plurality of keys for a corresponding first plurality of URL fragments derived from the first URL. Each of the first plurality of URL fragments may have the first domain name, the first path name, and a first respective permutation of the one or more first strings. The server may identify a second URL having a second domain name, a second path name, and one or more second strings. The server may generate a second plurality of keys using a corresponding second plurality of URL fragments derived from the second URL. Each of the second plurality of URL fragments may have the second domain and a second respective permutation of the second path name and the one or more second strings. The server may determine a match between at least one of the first plurality of keys of the record for the first URL and at least one of the second plurality of keys for the second URL. The server may provide an output for the second URL based at least on the match.

In some embodiments, the server may identify, responsive to determining the match between a key of the first plurality of keys and at least one of the second plurality of keys, a rule for the key to apply to the second URL to provide the output associated with the match. In some embodiments, the server may determine a score based at least on (i) the match between a key of the first plurality of keys and at least one of the second plurality of keys, (ii) a source identifier for a source of the second URL, (iii) one or more factors associated with the second URL. In some embodiments, the server may provide the output in accordance with the trust score.

In some embodiments, the server may identify a classification of abuse for the second URL in accordance with the match between a key of the first plurality of keys and at least one of the second plurality of keys. In some embodiments, the server may determine a lack of match between the first plurality of keys of the record for the first URL and a third plurality of keys for a third URL. In some embodiments, the server may provide a second output for the third URL based at least on the lack of match.

In some embodiments, the server may identify a classification of a third URL as safe responsive to a lack of a match between the first plurality of keys of the record for the first URL and a third plurality of keys for the third URL. In some embodiments, the server may receive the second URL from a data source. In some embodiments, the server may provide the output in accordance with a rule for the data source.

In some embodiments, the record may include a third plurality of keys for a corresponding third plurality of URL fragments derived from a third URL. Each of the third plurality of URL fragments may have the first domain name, a third path name, and a first respective permutation of one or more third strings. In some embodiments, each of the first plurality of keys in the record for the first URL may include a transposition of the first domain name and a respective hash of a corresponding first URL fragment of the first URL fragments. In some embodiments, the record may have a first plurality of values corresponding to a plurality of source identifiers. Each of the first plurality of values may identify a classification of abuse for a corresponding source identifier of the plurality of source identifiers.

### BRIEF DESCRIPTION OF THE DRAWINGS

FIG. 1 depicts a block diagram of a system for determining matches between Uniform Resource Locators (URLs), in accordance with an illustrative embodiment;

FIG. 2A depicts a block diagram of a process for cataloging records in the system for determining matches between URLs, in accordance with an illustrative embodiment;

FIG. 2B depicts a block diagram of a process for handling retrieval requests in the system for determining matches between URLs, in accordance with an illustrative embodiment;

FIG. 2C depicts a block diagram of a process for applying rules in the system for determining matches between keys corresponding to URL fragments, in accordance with an illustrative embodiment;

FIG. 3A depicts a block diagram of an example architecture for a trust and safety system for detecting threats using URLs, in accordance with an illustrative embodiment;

FIG. 3B depicts a block diagram of an example architecture for a trust and safety system for maintaining records for URLs, in accordance with an illustrative embodiment;

FIGS. 4A-C each depict a block diagram of an example of comparing URL fragments in in the system for determining matches between URL fragments, in accordance with an illustrative embodiment;

FIG. 5 depicts a flow diagram of a method of determining matches between Uniform Resource Locators (URL), in accordance with an illustrative embodiment; and

FIG. 6 depicts a block diagram of a server system and a client computer system in accordance with an illustrative embodiment

### DETAILED DESCRIPTION

Following below are more detailed descriptions of various concepts related to, and embodiments of, systems and methods for determining matches between Uniform Resource Locators (URL) fragments. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Section A describes determining matches between Uniform Resource Locators (URLs).

Section B describes a network environment and computing environment which may be useful for practicing various computing related embodiments described herein.

### A. Systems and Methods for Determining Matches Between Uniform Resource Locators (URLs)

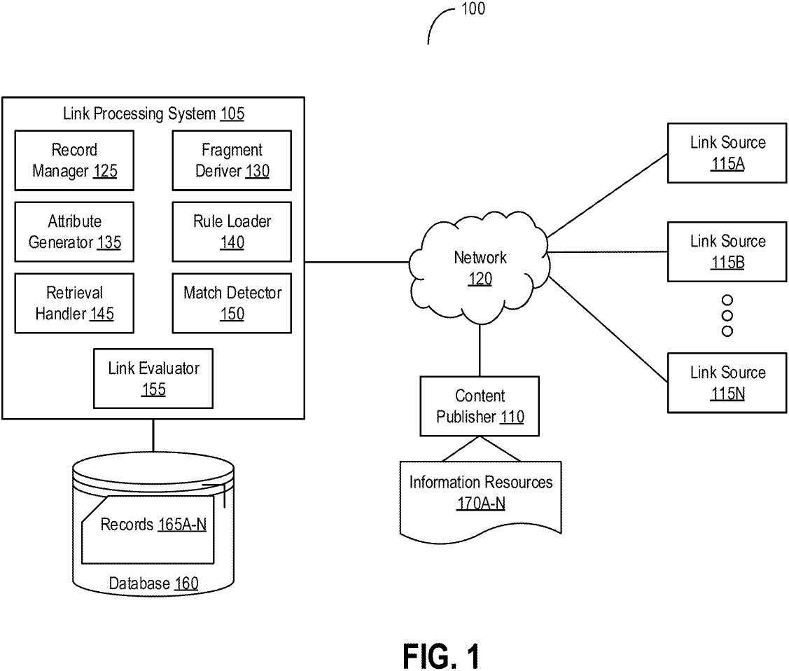

Referring now to FIG. 1, depicted is a block diagram of a system 100 for determining matches between Uniform Resource Locators (URLs). The system 100 may include at least one link processing system 105, at least one content publisher 110, and one or more link sources 115A-N (hereinafter generally referred to as a link source 115). The link processing system 105, the content publisher 110, and the link sources 115 may be communicatively coupled with one another via at least one network 120. The link processing system 105 may include at least one record manager 125, at least one fragment deriver 130, at least one attribute generator 135, at least one rule loader 140, at least one retrieval handler 145, at least one match detector 150, at least one link evaluator 155, and at least one database 160. The database 160 may store, maintain, or otherwise include a set of records 165A-N (hereinafter generally referred to as records 165). The content publisher 110 may host or provide one or more information resources 175A-N (hereinafter generally referred to as information resources 175). Each of the components in the system 100 (e.g., the link processing system 105, the content publisher 110, and the link sources 115, and their subcomponents) may be executed, processed, or implemented using hardware or a combination of hardware and software, such as the system 600 detailed herein in Section B.

The link processing system 105 may include servers or other computing devices to maintain records of Uniform Resource Locators (URLs) and process and perform lookups of URLs to check against the records. The link processing system 105 may include the record manager 125, the fragment deriver 130, the attribute generator 135, the rule loader 140, the retrieval handler 145, the match detector 150, and the link evaluator 155, among others. The link processing system 105 may include the database 160 or may have access to the database 160 (e.g., via the network 120). Each of the record manager 125, the fragment deriver 130, the attribute generator 135, the rule loader 140, the retrieval handler 145, the match detector 150, and the link evaluator 155 may include at least one processing unit, server, virtual server, circuit, engine, agent, appliance, or other logic device such as programmable logic arrays to perform the computer-readable instructions.

The content publisher 110 may include servers or other computing devices associated with a content provider entity to host and provide the one or more information resources 175. Each information resource 170 may include, for example, a webpage with content (e.g., textual, graphic, and multimedia content) to be presented on a client device communicatively coupled via the network 120. The content provider entity may correspond to an administrator for a website via which the webpages (examples of information resources 175) are accessible. The content publisher 110 and each information resource 170 hosted on the content publisher 110 can be uniquely referenced via a corresponding URL.

Each link source 115 (also referred herein as a data source) may include servers or computing devices associated with a vendor or administrator to provide URLs to reference the information resources 175 hosted on the content publisher 110. The link source 115 may send queries of a URL to the link processing system 105 to determine whether the URL match with any of the URLs in the records. In some embodiments, the link source 115 may be associated with the same content provider entity as the content publisher 110. In some embodiments, the link source 115 may be associated with a different entity that provides links referencing the information resources 175 hosted on the content publisher 110 . For example, the link source 115 may be a vendor or other associated party that provides encoded or shortened URLs for information resources 175 hosted on the content publisher 110. The encoded URL may be an abbreviated version of the full URL for the corresponding information resource 170.

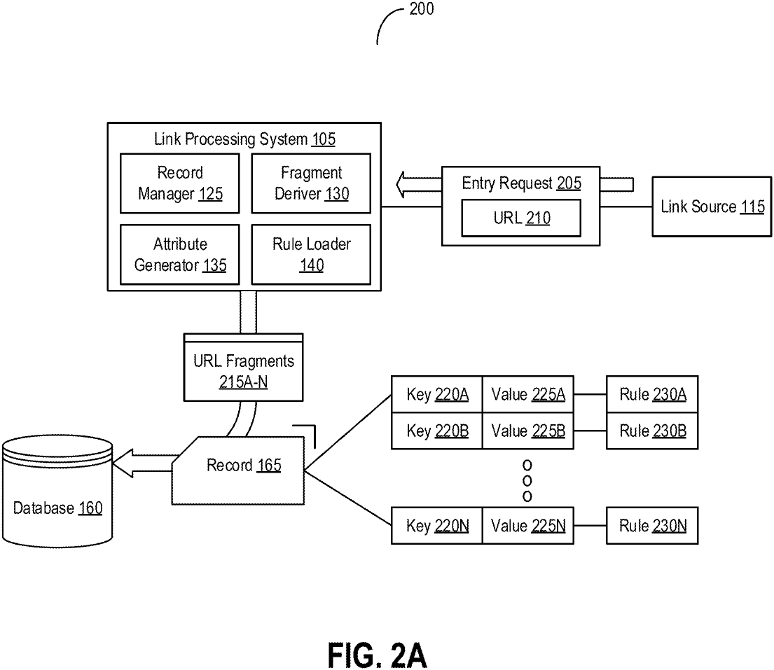

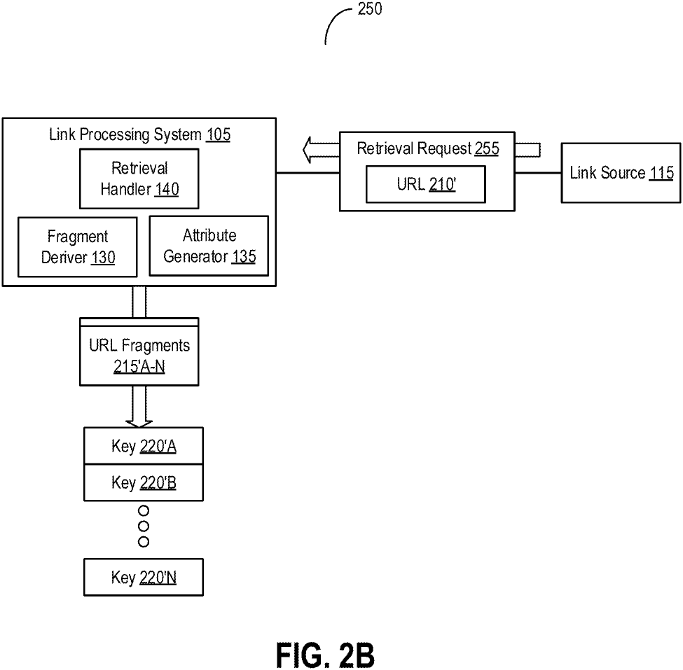

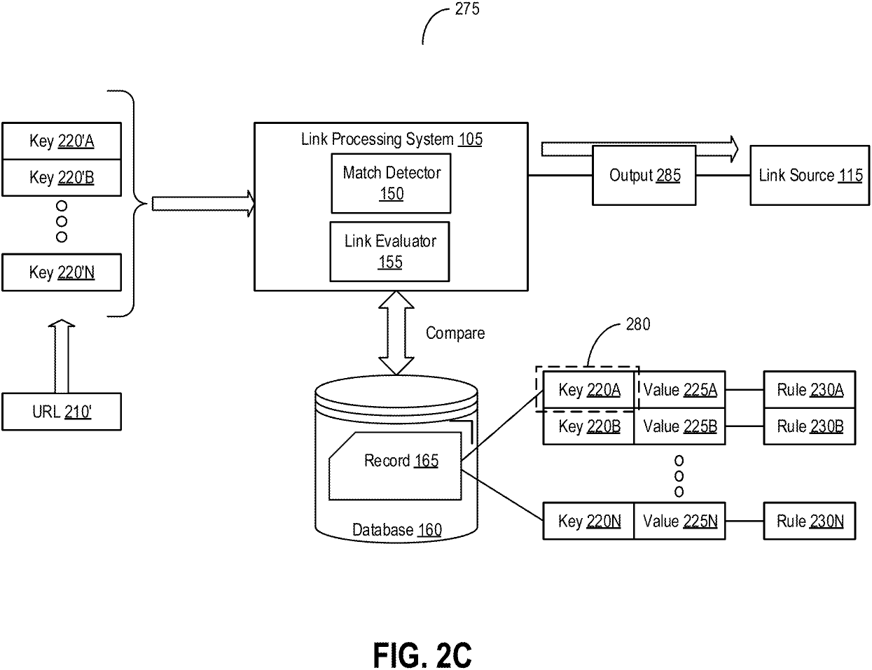

Referring now to FIG. 2A, depicted is a block diagram of a process 200 for cataloging records in the system 100 for determining matches between URLs. The process 200 may include or correspond to operations in the system 100 to generate and store records for URLs. Under the process 200, the record manager 125 executing on the link processing system 105 may retrieve, identify, or otherwise receive at least one entry request 205 from the link source 115. The entry request 205 may identify or include at least one URL 210 to be catalogued at the link processing system 105. In some embodiments, the entry request 205 may identify or include information to catalogue with the URL 210. In some embodiments, the information may be received separately from the URL 210 and the entry request 205.

With receipt, the record manager 125 may identify the URL 210 and related information from the entry request 205. The URL 210 may correspond to or reference one of the information resource 170 hosted by the content publisher 110. The URL 210 in the entry request 205 may have one or more string components, such as a scheme, a domain name, one or more path names, a query, among others. The scheme may identify which communications protocol is to be used (e.g., ftp, http, or https) in accessing the information resource 170. The domain name may identify the one or more servers (e.g., the content publisher 110) hosting the information resource 170. The domain name may include a prefix. The path names may define a hierarchical directory (e.g., from shallowest to deepest) and file name of the specific information resource 170. The query may identify additional information in accessing the information resource 170. The query may, for example, include one or more attribute-value pairs to be used input parameters for the information resource 170. For example, in the URL 210 “https://www.x.y/1/2.html?param=1”, the scheme may be “https://”, the domain name may be “www.x.y”, the prefix for the domain may be “x.y”, the path name may be “/1/2.html”, and the query may be “?param=1”.

In addition, the record manager 125 may identify the information associated with the URL 210. In some embodiments, the record manager 125 may identify the information from the entry request 205 or separately from the entry request 205 or the URL 210. The information may identify or include, for example: at least one classification of abuse for the URL 210 and the constituent fragments derived from the URL 210; a source identifier referencing the link source 115 from which the URL 210 is received or that generated the URL 210; and at least one rule to apply upon finding a match with the URL 210 and the constituents fragments derived from the URL 210, among others. The information (including the rule) may be in the form of a script, such as a HyperText Markup Language (HTML), Extensible Markup Language (XML), or JavaScript™. Upon identification of the URL 210 or the associated information, the record manager 125 may invoke or call the fragment deriver 130, the attribute generator 135, and the rule loader 140 to further process the URL 210 from the entry request 205.

The fragment deriver 130 executing on the link processing system 105 may derive, produce, or otherwise generate a set of URL fragments 215A-N (hereinafter generally referred to as URL fragments 215) from the URL 210 of the entry request 205. In some embodiments, the fragment deriver 130 may remove or discard the scheme from the URL 210 in generating the URL fragments 215. The set of URL fragments 215 may include various permutations of the string components of the URL 210. Each of the URL fragments 215 may include the domain name, the path name, and a respective permutation of other string components (e.g., the query string). For a subset of URL fragments 215, the domain name may include the prefix (e.g., “www” in “www.x.y”). For another subset of URL fragments 215, the domain name may lack the prefix. Across the set of URL fragments 215, the path name may be in full (e.g., including all the directories and file name for the information resource 170). For example, from the URL 210 “https://www. x.y/1/2.html?param=1”, the fragment deriver 130 may produce the set of URL fragments 215: “www.x.y/1/2.html”, “www.x.y/1/2.html? param=1”, “x.y/1/2.html”, and “x.y/1/2.html?param=1”.

The attribute generator 135 executing on the link processing system 105 may create, produce, or otherwise generate a set of keys 220A-N (hereinafter generally referred to as keys 220) for the set of URL fragments 215. Each key 220 may be generated from a corresponding URL fragment 215. To generate the key 220 for each URL fragment 215, the attribute generator 135 may calculate, determine, or generate a hash of the URL fragment 215. The hash may be generated in accordance with a hash algorithm, such as a one-way hash function (e.g., a universal one-way hash function), a cyclic redundancy check (e.g., CRC-16, CRC-32, or CRC-64), a checksum (e.g., Luhn algorithm), or a cryptographic hash function (e.g., Secure-Hash Algorithm (SHA-1, SHA-2, SHA-3) or Message Digest Algorithm (MD2, MD5, MD6)), among others. The attribute generator 135 may apply the hash algorithm to the URL fragment 215 to generate the corresponding hash. With the hash, the attribute generator 135 may generate the key 220 for the URL fragment 215 by combining the domain name of the URL 210 and the hash. In some embodiments, the attribute generator 135 may append a transposition (or a reversal) of the domain name from the URL 210 with the hash generated from the URL fragment 215 to generate the key 220. Each key 220 may be, for example, of the following format: “[reversed domain name]:[hash of URL fragment]”.

In addition, the attribute generator 135 may create, produce, or otherwise generate a set of values 225A-N (hereinafter generally referred to as values 225) for the set of URL fragments 215. The set of values 225 may be generated using at least a portion of the information associated with the URL 210 received from one link source 115 (e.g., as depicted) or multiple link sources 115. Each value 225 may include a set of alphanumeric characters or numeric values indicating the information, such as the classification of abuse for the URL 210 (and the URL fragments 215) and the source identifier for the corresponding link source 115, among others. For instance, the set of values 225 may be of the following form:

| 7a253f#abuse_type | bc9ee5#abuse_type | 8b85e1#abuse_type |
|---|---|---|
| 0×01 | 0×01 | 0×0F |

In the above example, the alphanumeric characters “7a253f”, “bc9ee5”, and “8b85e1” may be different source identifiers corresponding to different link sources 115, and the hexadecimal values “0×01”, “0×01”, and “0×0F” may represent respective classifications of abuse, such as phishing and malware, among others. The classification of abuse identified in the values 225 may include, for example, a botnet, exploitation, false positive, digital rights infringement, malware, misinformation, phishing, self-harm, spam, spyware, and adware, among others.

The rule loader 140 executing on the link processing system 105 may link, map, or otherwise associate a set of rules 230A-N (hereinafter generally referred to as rules 230) for the set of URL fragments 220. In some embodiments, the rule loader 140 may determine or generate the rules 230 using the information associated with the URL 210. The rule loader 140 may parse the information associated with the URL 210 to identify or extract the script. With the identification, the rule loader 140 may load the script from the information as the rule 230 for the URL 210 and the URL fragments 215 derived from the URL 210. In some embodiments, each rule 230 may be associated with the URL 210, and by extension across the URL fragments 215 derived from the URL 210. In some embodiments, each rule 230 may be associated with a respective key 220, and by extension a respective URL fragment 215. In some embodiments, each rule 230 may be associated with a pair of a respective key 220 and one of the values 225 corresponding to the key 220.

Each rule 230 may define, identify, or otherwise specify an action to carry out or an output to provide, in response to detecting a match with the URL fragment 215 corresponding to the respective key 220 associated with the rule 230. For instance, the rule 230 may specify: presentation of a prompt to warn the user that the information resource 170 linked via the URL 210 is prone to security faults, presentation of a prompt to notify the user that the information resource 170 linked via the URL 210 is inaccessible, blocking access to the information resource 170, or redirecting the end-user device to another information resource 170, among others. In addition, the rule 230 may specify a function to calculate a score, in response to detecting the match with the key 220 corresponding to the respective URL fragment 215. The score may be used to determine which action to carry out upon detecting the match. The function may include or identify one or more factors, such as: a trust factor indicating a degree that the link source 115 is safe, a geographic location from which the matching URL is accessed, a user profile of the end-user requesting the matching URL, and content on the information resource 170 linked via the matching URL, among others. In some embodiments, the rule 230 may also specify a threshold for the score at which the matching URL is to be categorized as abuse.

With the processing of the URL 210, the record manager 125 may create, produce, or otherwise generate at least one record 165 for the URL 210. The record 165 to include the set of keys 220 and the set of values 225 generated from the URL 210. In some embodiments, the record 165 may include sets of keys 220 and values 225 from multiple URLs 210 with the same domain name and differing paths. In addition, the record manager 215 may include the set of rules 230 associated with the sets of keys 220 and values 225 in the record 165. Upon generation, the record manager 125 may store and maintain the record 165 on the database 160. The records 165 may be maintained on the database 160 in accordance with any number of data structures, such as a hash table, an array, a linked list, a tree, a table, or a heap, among others. For example, the record manager 215 may store records 165 for different domain names in separate hash tables indexed by the hash value portion of the keys 220. Subsequent to storage, the record manager 125 may continue to update the records 165, including the keys 220, the values 225, and the rules 230 associated with the URL 210 from additional information received from the link sources 115.

Referring now to FIG. 2B, depicted is a block diagram of a process 250 for handling retrieval requests in the system 100 for determining matches between URLs. The process 250 may include or correspond to operations in the system 100 to determine whether a new URL matches with any of the URLs catalogued by the link processing system 105. Under the process 250, the retrieval handler 145 executing on the link processing system 105 may retrieve, identify, or otherwise receive at least one retrieval request 255. The retrieval request 255 may identify or include at least one URL 210′ against which to compare with the records 165. The retrieval request 255 may be received from the same link source 115 that provided the URL 210 as discussed above, another link source 115, or another computing device (e.g., associated with a vendor or administrator). The retrieval request 255 may also include other information, such as a source identifier referencing the link source 115 from which the URL 210′ is received or the link source 115 that generated the URL 210′. In some embodiments, the retrieval request 225 may be part of a request from an end-user computing device to access the information resource 170.

With receipt, the retrieval handler 145 may identify the URL 210′ from the retrieval request 255. The URL 210′ may correspond to or reference one of the information resource 170 hosted by the content publisher 110. The information resource 170 referenced by the URL 210′ may be the same or differ from the information resource 170 in at least one of the URLs 210 catalogued in the records 165 on the database 160. The URL 210′ in the retrieval request 255 may have one or more string components, such as a scheme, a domain name, one or more path names, a query, among others. The scheme may identify which communications protocol is to be used (e.g., ftp, http, or https) in accessing the information resource 170. The domain name may identify the one or more servers (e.g., the content publisher 110) hosting the information resource 170. The domain name may include a prefix. The path names may define a hierarchical directory (e.g., from shallowest to deepest) and file name of the specific information resource 170. The query may identify additional information in accessing the information resource 170. The query may, for example, include one or more attribute-value pairs to be used input parameters for the information resource 170. For example, in the URL 210′ “https://www.x.y/1/2.html?param=1”, the scheme may be “https://”, the domain name may be “www.x.y”, the prefix for the domain may be “x.y”, the path name may be “/1/2.html”, and the query may be “?param=1”. Upon identification of the URL 210, the retrieval handler 145 may invoke or call the fragment deriver 130, the attribute generator 135, the match detector 150, and the link evaluator 155 to further process the URL 210′ from the retrieval request 255.

The fragment deriver 130 may derive, produce, or otherwise generate a set of URL fragments 215′ A-N (hereinafter generally referred to as URL fragments 215′) from the URL 210′ of the retrieval request 255. In some embodiments, the fragment deriver 130 may remove or discard the scheme from the URL 210′ in generating the URL fragments 215′. The set of URL fragments 215′ may include various permutations of the string components of the URL 210′. Each of the URL fragments 215′ may include the domain name, the path name, and a respective permutation of other string components (e.g., the query string). For a subset of URL fragments 215′, the domain name may include the prefix (e.g., “www” in “www.x.y”). For another subset of URL fragments 215′, the domain name may lack the prefix. In at least one URL fragments 215′, the path name may be in full (e.g., including all the directories and file name for the information resource 170). In at least one URL fragment 215′, the path name be partial (e.g., including a subset of directories from shallowest to deepest in hierarchy level). For example, from the URL 210′ “https://www. x.y/1/2.html?param=1”, the fragment deriver 130 may produce the set of URL fragments 215′: “www.x.y/”, “www.x.y/1/”, “www.x.y/1/2.html”, “www.x.y/1/2.html?param=1”, “x.y/”, “x.y/1/”, “x.y/1/2.html”, ‘x.y/1/2.html?param=1″. The set of URL fragments 215’ from the URL 210′ may differ from the set of URL fragments 215 from the URL 210 in that the permutations of partial path names are included in the set of URL fragments 215′.

The attribute generator 135 may create, produce, or otherwise generate a set of keys 220′ A-N (hereinafter generally referred to as keys 220′) for the set of URL fragments 215′. Each key 220′ may be generated from a corresponding URL fragment 215′. To generate the key 220′ for each URL fragment 215′, the attribute generator 135 may calculate, determine, or generate a hash of the URL fragment 215′. The hash may be generated in accordance with a hash algorithm, such as the same as the hash algorithm used to generate the hash for the key 220. The attribute generator 135 may apply the hash algorithm to the URL fragment 215′ to generate the corresponding hash. With the hash, the attribute generator 135 may generate the key 220′ for the URL fragment 215′ by combining the domain name of the URL 210′ and the hash. In some embodiments, the attribute generator 135 may append a transposition (or a reversal) of the domain name from the URL 210′ with the hash generated from the URL fragment 215′ to generate the key 220′. Each key 220′ may have the same format as the key 220, and may be, for example, of the following format: “[reversed domain name]:[hash of URL fragment]”.

Referring now to FIG. 2C, depicted is a block diagram of a process 275 for applying rules in the system 100 for determining matches between URLs. The process 275 may include or correspond to operations performed in the system 100 to compare keys generated from URL fragments to identify the rules to apply to generate the outputs. Under the process 275, the match detector 150 executing on the link processing system 105 may determine whether a match 280 is present or absent between at least one of the keys 220′ from the URL 210′ and at least one of the keys 220 in the records 165. To determine, the match detector 150 may find, select, or identify the subset of records 165 on the database 160 using at least a common portion of the keys 220′, such as the transposition of the domain name from the URL fragment 210′ common across the set of keys 220′. For example, the match detector 150 may select a hash table corresponding to the records 165 having keys 220 with the reversal of the domain name same as the reversal of the domain name from the URL 210′. The selected hash table may contain the set of keys 220 with the same reversed domain name as the URL 210′, and respective hash values. If no records 165 are identified having the portion of the keys 220′ (e.g., the transposition of the domain name), the match detector 130 may determine an absence of a match between the set of keys 220 in the records 165 and the set of keys 220′ from the URL 210′. Otherwise, if a subset of records 165 are identified, the match detector 130 may continue with the determination.

With the identification of the records 165, the match detector 150 may determine compare the set of keys 220′ from the URL 210′ with the set of the keys 220 in the records 165. For each key 220′, the match detector 150 may identify the hash value calculated from the corresponding URL fragment 215′. The match detector 150 may compare the hash value from the key 220′ with the hash values from each of the keys 220 in the subset of records 165. When the hash value of at least one key 220 in the records 165 matches, equals, or corresponds to the hash value of at least one key 220′ from the URL 210′, the match detector 150 may determine the presence of the match 280 between the at least one key 220 and the at least one key 220′. The match detector 150 may also determine the presence of the match 280 between the URLs 210′ corresponding to the records 165 and the URL 210. Conversely, when the hash values of the keys 220 do not match, equal, or correspond to any of the hash values of the keys 220′ from the URL 210′, the match detector 150 may determine the absence of the match 280 between the set of keys 220 and the set of keys 220′. The match detector 150 may also determine the absence of the match 280 between the URLs 210′ corresponding to the records 165 and the URLs 210.

The link evaluator 155 executing on the link processing system 105 may generate, produce, or otherwise generate at least one output 285 in accordance with the presence or absence of the match 280. When the absence of the match 280 is determined, the link evaluator 155 may determine or identify a classification of the URL 210′ as benign, trustworthy, or otherwise safe. The link evaluator 155 may include the classification of the URL 210′ in the output 285. For example, the link evaluator 155 may include an indicator identifying the classification of the URL 210′ in the output 285. In some embodiments, the link evaluator 155 may include the URL 210′ from the retrieval request 255 into the output 285. With the inclusion, the link evaluator 155 may send, transmit, or otherwise provide the output 285 to the link source 115 or the computing device from which the retrieval request 255 is received. The output 285 may be displayed or presented on link source 115 (or the computing device). In some embodiments, when the request including the URL 210′ is from an end-user computing device to access the information resource 175, the link evaluator 155 may permit or allow the end-user computing device to continue with the access. The allowance may be in response to the determination of the absence of the match 280 or the classification of the URL 210′ as safe.

On the other hand, when the presence of the match 280 is determined, the link evaluator 155 may determine or identify a classification of abuse for the URL 210′ based on the match 280. To identify the classification, the link evaluator 155 may identify the value 225 associated with the key 220 of the match 280. As discussed above, the value 225 may indicate the classification of abuse (e.g., a botnet, exploitation, false positive, digital rights infringement, malware, misinformation, phishing, self-harm, spam, spyware, and adware) and the source identifier for the link source 115 from which the URL 210 is received, among others. The link evaluator 155 may read or parse the value 225 associated with the key 220 to identify the classification of abuse for the URL 210′. When there are multiple values 225 for different source identifiers, the link evaluator 155 may select the value 225 for the source identifier corresponding to the link source 115 from which the 210′ is received. With the identification, the link evaluator 155 may classify, determine, or otherwise identify the classification of abuse for the URL 210 from the value 225 as the classification of abuse for the URL 210′. Using the classification of abuse, the link evaluator 155 may generate the output 285 to identify or indicate the classification of abuse for the URL 210′. The output 285 may be displayed or presented on link source 115 (or the computing device).

In addition, the link evaluator 155 may find, select, or otherwise identify the rule 230 associated with the key 220 determined to have the match 280 with at least one of the keys 220′ from the URL 210′. In some embodiments, the link evaluator 155 may find the rule 230 for the link source 115, using the matching key 220 and value 225 corresponding to the source identifier for the link source 115. With the identification, the link evaluator 155 may apply the rule 230 to the URL 210′ to provide the output 285. As discussed above, the rule 230 may specify the action to carry out or the output to provide. For example, when the request including the URL 210′ is from an end-user computing device to access the information resource 170, the link evaluator 155 may perform the action the end-user computing device in accordance with the rule 230. In this example, the action specified by the rule 230 may include: presentation of a prompt to warn the user that the information resource 170 linked via the URL 210′ of security risks, presentation of a prompt to notify the user that the information resource 170 is inaccessible, blocking access to the information resource 170, or redirecting the end-user device to another information resource 170, among others. The link evaluator 155 may provide an instruction to the end-user computing device to carry out the action specified by the rule 230.

In some embodiments, the link evaluator 155 may calculate, generate, or otherwise determine at least one score for the URL 210′ with the match 280. The determination of the score may be based on a function defined by the rule 230. As discussed above, the function may take in factors, such as: a trust factor indicating a degree that the link source 115 is safe, a geographic location from which the matching URL is accessed, a user profile of the end-user requesting the matching URL, and content on the information resource 170 linked via the matching URL, among others. The link evaluator 155 may identify the trust factor using the source identifier for the link source 115, the geographic location and the user profile using the request from the end-user computing device, and the content from accessing the information resource 170 linked via the URL 210′, among others. With the identifications, the link evaluator 155 may determine the score for the URL 210′.

Using the score, the link evaluator 155 may determine whether the URL 210′ is to be classified as abuse or safe in accordance with the rule 230. To determine, the link evaluator 155 may compare the score with the threshold defined by the rule 230. If the score satisfies (e.g., is greater than or equal to) the threshold, the link evaluator 155 may determine that the URL 210′ is abusive. The link evaluator 155 may use the classification of abuse as identified in the corresponding value 225 for the URL 210′. The link evaluator 155 may also perform the action or provide the output 285 as specified by the rule 230. On the other hand, if the score does not satisfy (e.g., is less than or equal to) the threshold, the link evaluator 155 may determine that the URL 210′ is safe. Based on the determination, the link evaluator 155 may generate and provide the output 285. The output 285 may include or identify the classification of the URL 210′ as abuse (including type) or safe. The output 285 may also include the prompt or instructions for the action as defined by the rule 230. Upon receipt, the link source 115 (or the computing device) in turn may carry out the action specified in the output 285 or present the information included in the output 285.

In this manner, the link processing system 105 may be able to quickly and precisely process the URLs 210′ to identify matches with the catalogued URLs 210 to determine whether the URLs 210′ are safe or abusive. To that end, the linking processing system 105 may dynamically generate keys 220 using URL fragments 215 of URLs 210 to quickly compare against keys 220′ generated using URL fragments 215′ from newly received URLs 210. The linking processing system 105 may also provide for the capability to define specific classifications using values 225 granular rules 230 for any path in the URL 210. Since keys 220 and 220′are derived from the URL fragments 215 and 215′ that in turn are derived from portions of URLs 210 and 210′, the linking system 105 may be able to quickly compare any two URLs 210 and 210′. This way of comparison may reduce the amount of time from processing such URLs 210 and 210′, thereby reducing the consumption of computing resources (e.g., processor and memory). Furthermore, the output 285 indicating the classification of the URL 210′ may shield and protect against potentially harmful exposure to malware, phishing, spam, and spyware, among others, thereby improving the security of the overall system 100, including any recipients of the URLs 210′.

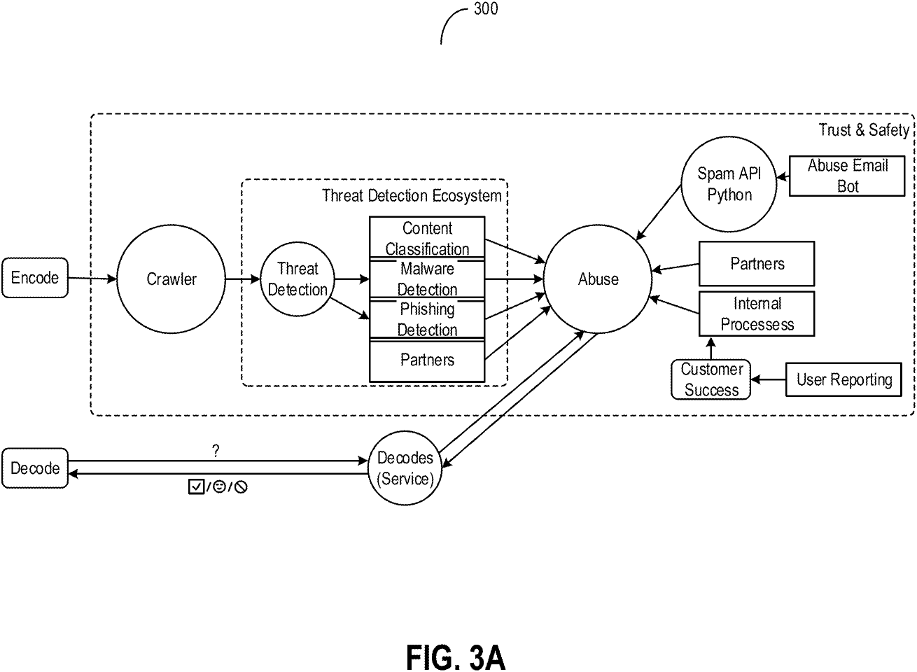

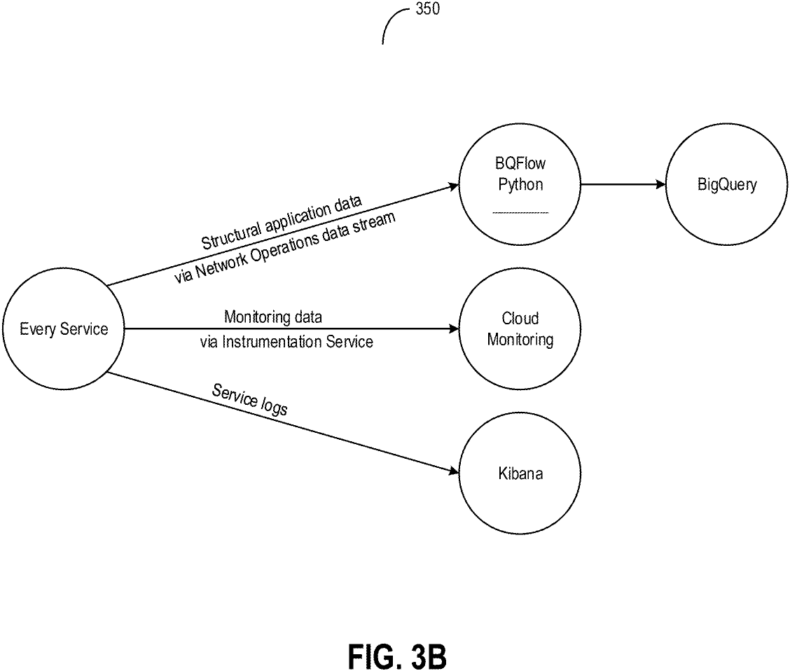

Referring now to FIG. 3A, depicted is a block diagram of an architecture 300 for a trust and safety system for detecting threats using URLs. The trust and safety system may be implemented using the link processing system 105 described above. The safety may have a crawler to receive encoded URLs, and pass the URLs to a threat detection ecosystem. The ecosystem may detect whether the URL represents at least one of the threats, using content classification, malware detection, and phishing detection, among others. The abuse detector may take the results of the threat detection ecosystem, including partner services. The abuse detector may also obtain input from spam detection, internal processes (e.g., customer or user reporting), and other partner services, among others. Using the inputs, the abuse detector may produce an output to provide to a decoder service. The decoder service may decode the corresponding URLs to provide to the end-users and other linking services.

Referring now to FIG. 3B, depicted is a block diagram of an architecture 350 for a trust and safety system for maintaining records for URLs. The trust and safety system may request data from various services, such as structural application data from a network operations tool (e.g., NetQ BQFlow), monitoring data and metrics from an instrumentation service (e.g., OpenCensus) on the cloud, and service logs from a database (e.g., Kibana), among others. The data may be used to generate the records of URLs as well as related information.

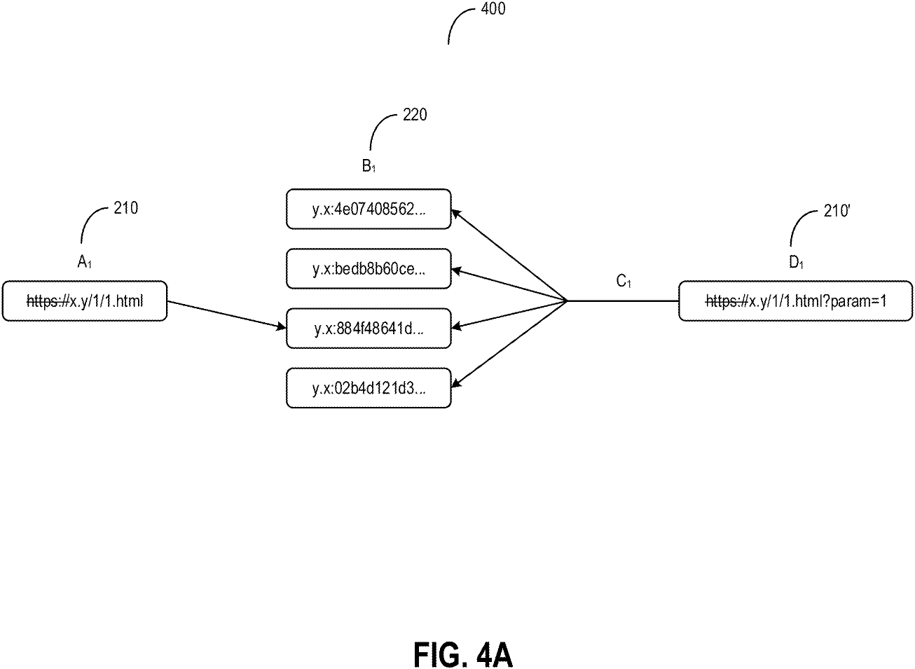

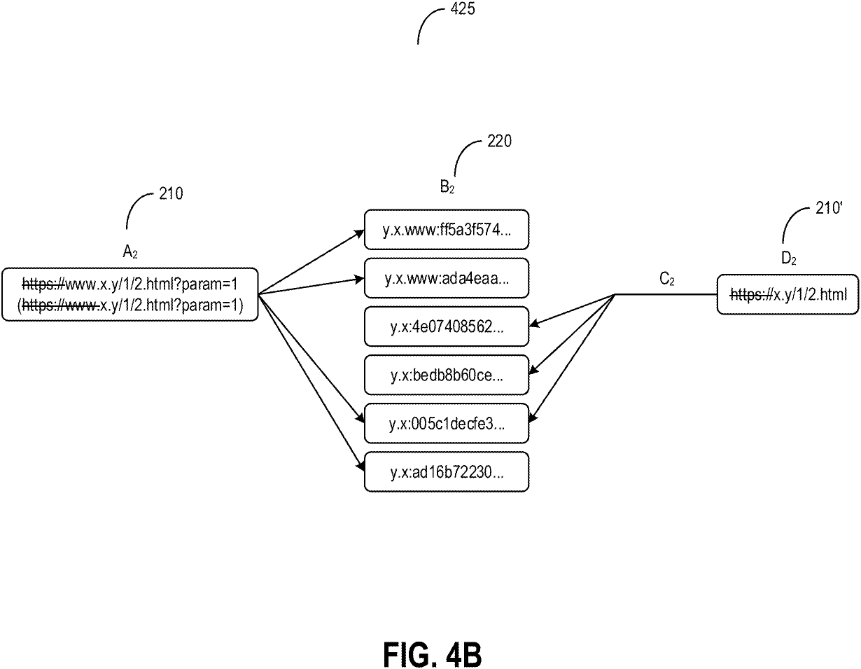

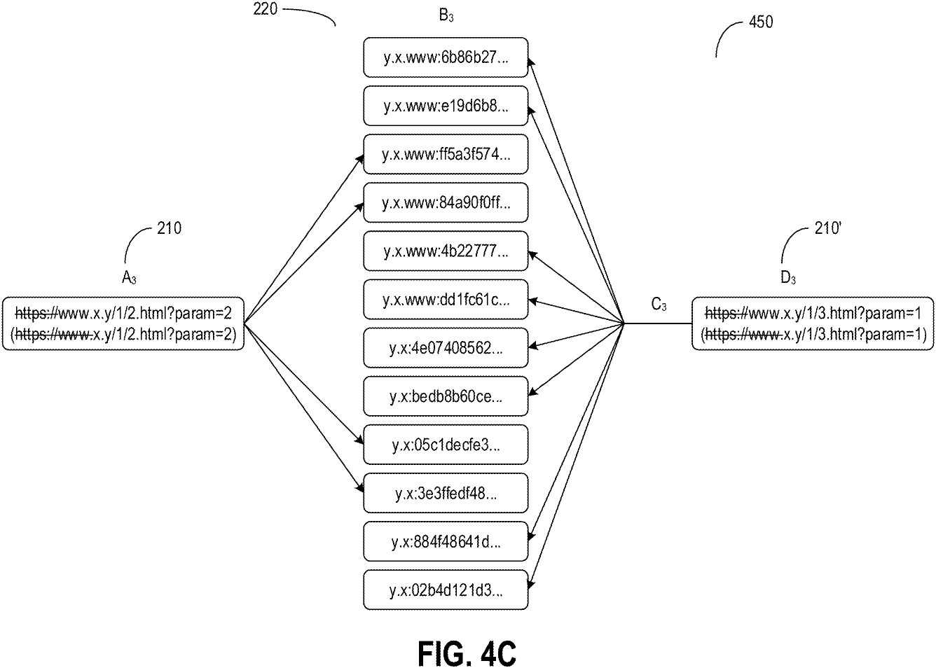

Referring now to FIG. 4A, depicted is a block diagram of an example 400 of comparing URL fragments in in the system for determining matches between URL fragments. In the depicted example, the record manager 125 may receive the URL 210 A₁ “x.y/1/1.html”. The attribute generator 135 may use URL fragments 215 from the URL 210 to generate the record 170 with the set of keys 220 B₁, one of which corresponds to the URL 210 A₁. Subsequently, the retrieval handler 140 may receive the URL 210′ D₁ “https://x.y/1/1.html?param=1” against which to check the record 170. Based on permutations of the URL 210′, the fragment deriver 130 may generate the URL fragments 215′ B₁: “x.y/”, “x.y/1/”, “x.y/1/1.html”, and “x.y/1/1.html?param=1”. Using the URL fragments 215′, the attribute generator 135 may generate keys 220′. The match detector 140 may determine a match 280 between the key 220′ for “x.y/1/1.html” and the key 220 for “x.y/1/1.html”. The link evaluator 145 may provide the output 285 based on the determination of the presence of the match 280.

Referring now to FIG. 4B, depicted is a block diagram of an example 425 of comparing URL fragments in in the system for determining matches between URL fragments. In the depicted example, the record manager 125 may receive a report of URL 210 A₂ ““https://www.x.y/1/2.html?param=1″. The attribute generator 135 may use URL fragments 215 from the URL 210 to generate the record 170 with the set of keys 220 B₂: “www.x.y/1/2.html”, “www.x.y/1/2.html?param=1”, “x.y/1/2.html”, and “x.y/1/2.html?param=1”. Later, an end-user may send a request to access the information resource 170 linked via the URL 210′ D₂ “https://x.y/1/2 html”. Based on permutations of the URL 210′, the fragment deriver 130 may generate the URL fragments 215′ B₂: “x.y/”, “x.y/1/”, and “x.y/1/2.html”. Using the URL fragments 215′, the attribute generator 135 may generate keys 220′. The match detector 140 may determine a match 280 between the key 220′ for “x.y/1/2.html” and the key 220 for “x.y/1/1.html”.The link evaluator 145 may provide the output 285 based on the determination of the presence of the match 280.

Referring now to FIG. 4C, depict is a block diagram of an example 450 of comparing URL fragments in in the system for determining matches between URL fragments. In the depicted example, the record manager 125 may receive a report of URL 210 A₃: “https://www.x.y/1/2.html?param=2”. The attribute generator 135 may use URL fragments 215 from the URL 210 to generate the record 170 with the set of keys 220 B₃: “www.x.y/1/2.html”, “www.x.y/1/2.html?param=2”, “x.y/1/2.html”, and “x.y/1/2.html?param=2”. Later, an end-user may send a request to access the information resource 170 linked via the URL 210′ D₃: “”https://www.x.y/1/3.html?param=1″. Based on permutations of the URL 210′, the fragment deriver 130 may generate the URL fragments 215′ B₃: “x.y/”, “x.y/1/”, “x.y/1/3.html”, “x.y/1/3.html?param=1”, “www.x.y/”, “www.x.y/1/”, “www.x.y/1/3.html”, and “www.x.y/1/3.html?param=1”. The match detector 140 may determine a lack of match between the key 220′ for “https://www.x.y/1/2.html?param=2” with none of the keys 220. The link evaluator 145 may provide the output 285 based on the determination of the absence of the match 280.

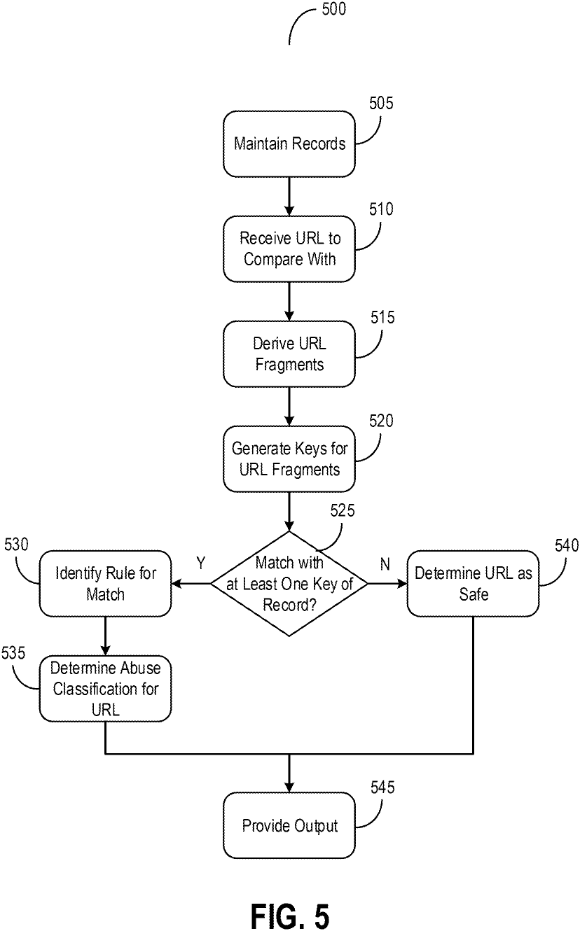

Referring now to FIG. 5, depicted is a flow diagram of a method 500 of determining matches between Uniform Resource Locators (URL) fragments. The method 500 may be performed by any of the components described herein, such as the link processing system 105 detailed herein in conjunction with FIGS. 1-4C or the server system 600 described in Section B. Under method 500, a server (e.g., the link processing system 105) may maintain records (e.g., records 165) (505). The service may receive a Uniform Resource Locator (URL) (e.g., URL 210) to compare with (510). The server may derive URL fragments (e.g., the URL fragments 215) (515). The service may generate keys (e.g., keys 220′) for URL fragments (520). The server may determine whether at least one key of the received URL matches with at least one key (e.g., the key 220) of the record (525). If the match is determined, the server may identify a rule (e.g., the rule 230) for the match (530). The server may determine an abuse classification for the URL (535). On the other hand, if no match is determined, the server may determine the URL as safe (540). The server may provide an output (e.g., the output 285) based on the determination (545).

### B. Computing and Network Environment

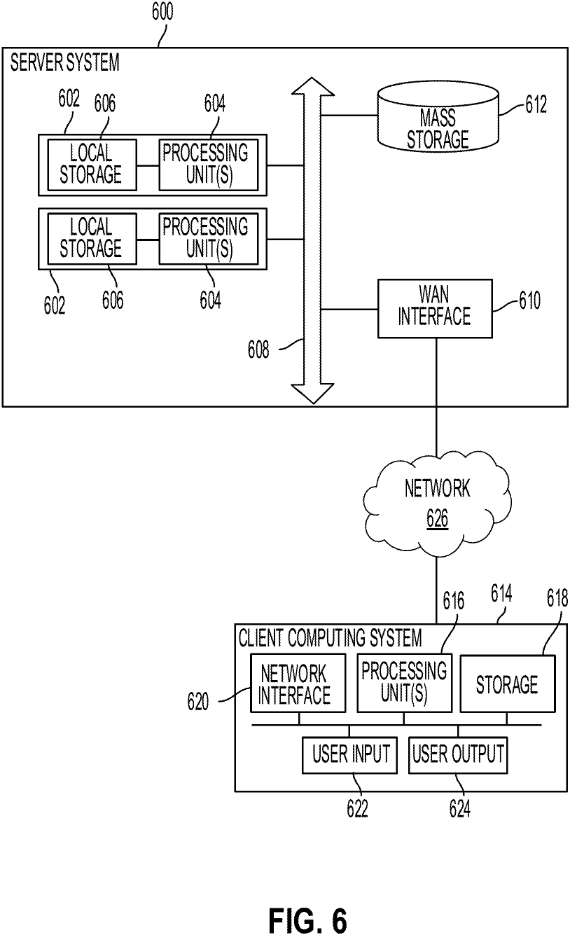

Various operations described herein can be implemented on computer systems. FIG. 6 shows a simplified block diagram of a representative server system 600, client computing system 614, and network 626 usable to implement certain embodiments of the present disclosure. In various embodiments, server system 600 or similar systems can implement services or servers described herein or portions thereof. Client computing system 614 or similar systems can implement clients described herein. The system 600 described herein can be similar to the server system 600. Server system 600 can have a modular design that incorporates a number of modules 602 (e.g., blades in a blade server embodiment); while two modules 602 are shown, any number can be provided. Each module 602 can include processing unit(s) 604 and local storage 606.

Processing unit(s) 604 can include a single processor, which can have one or more cores, or multiple processors. In some embodiments, processing unit(s) 604 can include a general-purpose primary processor as well as one or more special-purpose co-processors such as graphics processors, digital signal processors, or the like. In some embodiments, some or all processing units 604 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 604 can execute instructions stored in local storage 606. Any type of processors in any combination can be included in processing unit(s) 604.

Local storage 606 can include volatile storage media (e.g., DRAM, SRAM, SDRAM, or the like) and/or non-volatile storage media (e.g., magnetic or optical disk, flash memory, or the like). Storage media incorporated in local storage 606 can be fixed, removable or upgradeable as desired. Local storage 606 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 604 need at runtime. The ROM can store static data and instructions that are needed by processing unit(s) 604. The permanent storage device can be a non-volatile read-and-write memory device that can store instructions and data even when module 602 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some embodiments, local storage 606 can store one or more software programs to be executed by processing unit(s) 604, such as an operating system and/or programs implementing various server functions such as functions of the system 100 of FIG. 1 or any other system described herein, or any other server(s) associated with system 100 or any other system described herein.

“Software” refers generally to sequences of instructions that, when executed by processing unit(s) 604 cause server system 600 (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing unit(s) 604. Software can be implemented as a single program or a collection of separate programs or program modules that interact as desired. From local storage 606 (or non-local storage described below), processing unit(s) 604 can retrieve program instructions to execute and data to process in order to execute various operations described above.

In some server systems 600, multiple modules 602 can be interconnected via a bus or other interconnect 608, forming a local area network that supports communication between modules 602 and other components of server system 600. Interconnect 608 can be implemented using various technologies including server racks, hubs, routers, etc.

A wide area network (WAN) interface 610 can provide data communication capability between the local area network (interconnect 608) and the network 626, such as the Internet. Technologies can be used, including wired (e.g., Ethernet, IEEE 602.3 standards) and/or wireless technologies (e.g., Wi-Fi, IEEE 602.11 standards).

In some embodiments, local storage 606 is intended to provide working memory for processing unit(s) 604, providing fast access to programs and/or data to be processed while reducing traffic on interconnect 608. Storage for larger quantities of data can be provided on the local area network by one or more mass storage subsystems 612 that can be connected to interconnect 608. Mass storage subsystem 612 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 612. In some embodiments, additional data storage resources may be accessible via WAN interface 610 (potentially with increased latency).

Server system 600 can operate in response to requests received via WAN interface 610. For example, one of modules 602 can implement a supervisory function and assign discrete tasks to other modules 602 in response to received requests. Work allocation techniques can be used. As requests are processed, results can be returned to the requester via WAN interface 610. Such operation can generally be automated. Further, in some embodiments, WAN interface 610 can connect multiple server systems 600 to each other, providing scalable systems capable of managing high volumes of activity. Other techniques for managing server systems and server farms (collections of server systems that cooperate) can be used, including dynamic resource allocation and reallocation.

Server system 600 can interact with various user-owned or user-operated devices via a wide-area network such as the Internet. An example of a user-operated device is shown in FIG. 6 as client computing system 614. Client computing system 614 can be implemented, for example, as a consumer device such as a smartphone, other mobile phone, tablet computer, wearable computing device (e.g., smart watch, eyeglasses), desktop computer, laptop computer, and so on.

For example, client computing system 614 can communicate via WAN interface 610. Client computing system 614 can include computer components such as processing unit(s) 616, storage device 618, network interface 620, user input device 622, and user output device 624. Client computing system 614 can be a computing device implemented in a variety of form factors, such as a desktop computer, laptop computer, tablet computer, smartphone, other mobile computing device, wearable computing device, or the like.

Processing unit(s) 616 and storage device 618 can be similar to processing unit(s) 604 and local storage 606 described above. Suitable devices can be selected based on the demands to be placed on client computing system 614; for example, client computing system 614 can be implemented as a “thin” client with limited processing capability or as a high-powered computing device. Client computing system 614 can be provisioned with program code executable by processing unit(s) 616 to enable various interactions with server system 600.

Network interface 620 can provide a connection to the network 626, such as a wide area network (e.g., the Internet) to which WAN interface 610 of server system 600 is also connected. In various embodiments, network interface 620 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 622 can include any device (or devices) via which a user can provide signals to client computing system 614; client computing system 614 can interpret the signals as indicative of particular user requests or information. In various embodiments, user input device 622 can include any or all of a keyboard, touch pad, touch screen, mouse or other pointing device, scroll wheel, click wheel, dial, button, switch, keypad, microphone, and so on.

User output device 624 can include any device via which client computing system 614 can provide information to a user. For example, user output device 624 can include a display to display images generated by or delivered to client computing system 614. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that function as both input and output device. In some embodiments, other user output devices 624 can be provided in addition to or instead of a display. Examples include indicator lights, speakers, tactile “display” devices, printers, and so on.

Some embodiments include electronic components, such as microprocessors, storage and memory that store computer program instructions in a computer-readable storage medium. Many of the features described in this specification can be implemented as processes that are specified as a set of program instructions encoded on a computer-readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 604 and 616 can provide various functionality for server system 600 and client computing system 614, including any of the functionality described herein as being performed by a server or client, or other functionality.

It will be appreciated that server system 600 and client computing system 614 are illustrative and that variations and modifications are possible. Computer systems used in connection with embodiments of the present disclosure can have other capabilities not specifically described here. Further, while server system 600 and client computing system 614 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present disclosure can be realized in a variety of apparatus including electronic devices implemented using any combination of circuitry and software.

While the disclosure has been described with respect to specific embodiments, one skilled in the art will recognize that numerous modifications are possible. Embodiments of the disclosure can be realized using a variety of computer systems and communication technologies including but not limited to the specific examples described herein. Embodiments of the present disclosure can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present disclosure may be encoded and stored on various computer-readable storage media; suitable media include magnetic disk or tape, optical storage media such as compact disk (CD) or DVD (digital versatile disk), flash memory, and other non-transitory media. Computer-readable media encoded with the program code may be packaged with a compatible electronic device, or the program code may be provided separately from electronic devices (e.g., via Internet download or as a separately packaged computer-readable storage medium).

Thus, although the disclosure has been described with respect to specific embodiments, it will be appreciated that the disclosure is intended to cover all modifications and equivalents within the scope of the following claims.

What is claimed is:

1. A method of determining a match between uniform resource locators (URL) fragments, comprising:
maintaining, by a server, a record for a first URL against which to compare, the first URL having a first domain name, a first path name, and one or more first strings, the record comprising a first plurality of keys for a corresponding first plurality of URL fragments derived from the first URL, each of the first plurality of URL fragments having the first domain name, the first path name, and a first respective permutation of the one or more first strings;
identifying, by the server, a second URL having a second domain name, a second path name, and one or more second strings;
generating, by the server, a second plurality of keys using a corresponding second plurality of URL fragments derived from the second URL, each of the second plurality of URL fragments having the second domain and a second respective permutation of the second path name and the one or more second strings;
determining, by the server, a match between at least one of the first plurality of keys of the record for the first URL and at least one of the second plurality of keys for the second URL; and
providing, by the server, an output for the second URL based at least on the match.

2. The method of claim 1, further comprising identifying, by the server, responsive to determining the match between a key of the first plurality of keys and at least one of the second plurality of keys, a rule for the key to apply to the second URL to provide the output associated with the match.

3. The method of claim 1, further comprising:
determining, by the server, a score based at least on (i) the match between a key of the first plurality of keys and at least one of the second plurality of keys, (ii) a source identifier for a source of the second URL, (iii) one or more factors associated with the second URL, and
wherein providing the output further comprises providing the output in accordance with the score.

4. The method of claim 1, further comprising identifying, by the server, a classification of abuse for the second URL in accordance with the match between a key of the first plurality of keys and at least one of the second plurality of keys.

5. The method of claim 1, further comprising:
determining, by the server, a lack of match between the first plurality of keys of the record for the first URL and a third plurality of keys for a third URL; and
providing, by the server, a second output for the third URL based at least on the lack of match.

6. The method of claim 1, further comprising identifying, the server, a classification of a third URL as safe responsive to a lack of a match between the first plurality of keys of the record for the first URL and a third plurality of keys for the third URL.

7. The method of claim 1, wherein identifying the second URL further comprises receiving the second URL from a data source; and
wherein providing the output further comprises providing the output in accordance with a rule for the data source.

8. The method of claim 1, wherein the record further comprises a third plurality of keys for a corresponding third plurality of URL fragments derived from a third URL, each of the third plurality of URL fragments having the first domain name, a third path name, and a first respective permutation of one or more third strings.

9. The method of claim 1, wherein each of the first plurality of keys in the record for the first URL further comprises a transposition of the first domain name and a respective hash of a corresponding first URL fragment of the first URL fragments.

10. The method of claim 1, wherein the record further comprises a first plurality of values corresponding to a plurality of source identifiers, each of the first plurality of values identifying a classification of abuse for a corresponding source identifier of the plurality of source identifiers.

11. A system for determining a match between uniform resource locators (URL) fragments, comprising:
at least one server having one or more processors coupled with memory, configured to:
maintain a record for a first URL against which to compare, the first URL having a first domain name, a first path name, and one or more first strings, the record comprising a first plurality of keys for a corresponding first plurality of URL fragments derived from the first URL, each of the first plurality of URL fragments having the first domain name, the first path name, and a first respective permutation of the one or more first strings;
identify second URL having a second domain name, a second path name, and one or more second strings;
generate a second plurality of keys using a corresponding second plurality of URL fragments derived from the second URL, each of the second plurality of URL fragments having the second domain and a second respective permutation of the second path name and the one or more second strings;
determine a match between at least one of the first plurality of keys of the record for the first URL and at least one of the second plurality of keys for the second URL; and
provide an output for the second URL based at least on the match.

12. The system of claim 11, wherein the at least one server is further configured to identify, responsive to determining the match between a key of the first plurality of keys and at least one of the second plurality of keys, a rule for the key to apply to the second URL to provide the output associated with the match.

13. The system of claim 11, wherein the at least one server is further configured to:
determine a score based at least on (i) the match between a key of the first plurality of keys and at least one of the second plurality of keys, (ii) a source identifier for a source of the second URL, (iii) one or more factors associated with the second URL, and
provide the output in accordance with the score.

14. The system of claim 11, wherein the at least one server is further configured to identify a classification of abuse for the second URL in accordance with the match between a key of the first plurality of keys and at least one of the second plurality of keys.

15. The system of claim 11, wherein the at least one server is further configured to:
determine a lack of match between the first plurality of keys of the record for the first URL and a third plurality of keys for a third URL; and
provide a second output for the third URL based at least on the lack of match.

16. The system of claim 11, wherein the at least one server is further configured to identify a classification of a third URL as safe responsive to a lack of a match between the first plurality of keys of the record for the first URL and a third plurality of keys for the third URL.

17. The system of claim 11, wherein the at least one server is further configured to:
receive the second URL from a data source; and
provide the output in accordance with a rule for the data source.

18. The system of claim 11, wherein the record further comprises a third plurality of keys for a corresponding third plurality of URL fragments derived from a third URL, each of the third plurality of URL fragments having the first domain name, a third path name, and a first respective permutation of one or more third strings.

19. The system of claim 11, wherein each of the first plurality of keys in the record for the first URL further comprises a transposition of the first domain name and a respective hash of a corresponding first URL fragment of the first URL fragments.

20. The system of claim 11, wherein the record further comprises a first plurality of values corresponding to a plurality of source identifiers, each of the first plurality of values identifying a classification of abuse for a corresponding source identifier of the plurality of source identifiers.
